(19) United States
(12) Patent Application Publication
(10) Pub. No.: US 2010/0003077 A1
(43) Pub. Date: Jan. 7, 2010

(54) Apparatus and Method for Assembling Structural Components

(76) Inventor: Sam Kelley, Birmingham, AL (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/166,863

(22) Filed: Jul. 2, 2008

(51) Int. Cl. F16B 12/00; F16B 9/02

(52) U.S. Cl. 403/409.1; 403/246

(57) ABSTRACT

A method and device for joining structural members, such as furniture components. A joining wedge is a substantially U-shaped or boxed shaped device having side surfaces or legs interconnected by a top surface and flanges extending outwardly of the legs or side surfaces of the wedge. The wedge is attached to one structural member and is received in a keyed slot defined in another structural member. The structural members are moved relative to one another such that the flanges cooperatively engage a subjacent wall of the keyed slot.

### BACKGROUND OF THE INVENTION

1. Filed of the Invention

The present invention relates to an apparatus and method for assembling structural components. More particularly, the invention relates to joining structural components for furnishings, such as furniture, cabinetry, shelving units, and the like. With even greater particularity, the invention relates to an apparatus and method of joining structural components for final assembly, wherein the final assembly does not require the use of special tools.

2. Description of the Related Art

It has become increasingly popular for manufacturers to produce furnishings, such as furniture, cabinetry, shelving units, and the like where the furnishings are shipped in an unassembled condition for ease of transport and other such considerations, and placed in a final assembled condition by either a retail outlet for showroom display or the consumer end user. Various fasteners have been employed that may be complicated to use, may damage easily, may require special tools, or may result in damage to the structural members of the furnishings when they are not assembled correctly. By way of example, popular cam-lock fasteners typically rely on a post that is threadlingly inserted into one structural member and a rotatable cam that is inserted into an opening in the second structural member. The cam is rotated to capture a head on the post that is inserted through a bore in the edge of the second structural member. These arrangements may present difficulty when the structural members become misaligned during assembly, particularly when there are a plurality of such posts, such that either the threaded engagement of the post breaks the first structural member, or the head end of the post damages the bore edge of the second structural member. These configurations may also present the potential for damaged when the cam is misaligned in its bore, and the surface of the rotating the cam. In light of these and other limitations in the art, it is desirable to provide a joining device and method that are easy to use and avoid the problems of existing fasteners in the art.

### BRIEF DESCRIPTION OF THE SEVERAL DRAWINGS

FIG. 1 is a perspective view of the alignment of two structural members to be joined in accordance with the present invention;

FIG. 2 is an end view of a joining wedge;

FIG. 3 is an overhead plan view of a joining wedge;

FIG. 4 is a side elevational view of a joining wedge;

FIG. 5 is a perspective view of a joining wedge;

FIG. 6 is a view illustrating the attachment of a joining wedge to a first structural member;

FIG. 7A is cross sectional view of a first structural member depicting a detailed view of a keyed slot taken along line A-A of FIG. 1;

FIG. 7B is a cross sectional view of a first structural member depicting a detailed view of a keyed slot taken along line B-B of FIG. 1;

FIG. 7C is a cross sectional view of a hollow first structural member that is a detailed view of a keyed slot taken along line B-B of FIG. 1;

FIG. 8A is a cross sectional view of a first structural member depicting a detailed view of a keyed slot with a joining wedge taken along line A-A of FIG. 1;

FIG. 8B is a cross sectional view of a first structural member depicting a detailed view of a keyed slot with a joining wedge taken along line B-B of FIG. 1;

FIG. 8C is a cross sectional view of a hollow first structural member depicting a detailed view of a keyed slot and joining wedge taken along line B-B of FIG. 1; and

FIG. 9 is an perspective view of a finished structural piece joined in accordance with the present invention.

### BRIEF SUMMARY OF THE INVENTION

Briefly described the invention includes a device and a method of forming joints in structural components, particularly structural components of furniture.

The invention includes a wedge for joining structural members, the wedge having first and second side surface that are substantially parallel and interconnected by a top surface member. Flanges extend outwardly from and substantially perpendicular to the respective side surface members. Preferably, the distance between the top surface member and an upper surface of flanges varies between the ends of the wedge. The wedges may be readily stamped or formed from sheet metal, or may be solid elements.

The wedges are attached to one structural member and are received in a keyed slot formed in another structural member. The keyed slot has a first opening that can receive the body of the wedge and has a second opening, coterminous with the first opening such that the second opening defines a wall that is subjacent to a mating surface of its respective structural member. The respective structural members are joined by the engagement of the flanges on the wedge with the will the surface of the subjacent wall. The invention also contemplates a method of joining structural members having the wedge and keyed slot for receiving the wedge.

### DETAILED DESCRIPTION OF THE INVENTION

With reference to the figures in which like numerals represent like elements throughout, embodiments of the present invention are shown. The figures and the following description are for a limited number of embodiments for ease of understanding. However, the invention is not limited to these illustrative embodiments.

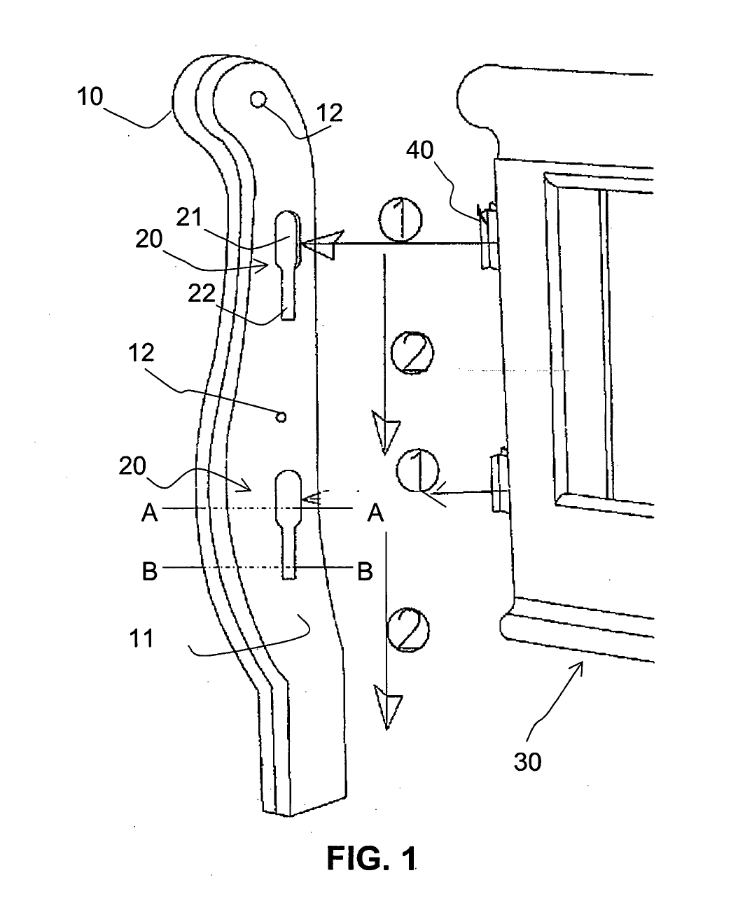

In reference to FIG. 1, structural members to be joined in accordance with the present invention are shown in their respective alignments for joining. For purposes of illustration the embodiment of the present invention shown is that of a headboard for a bed frame. However, as will be appreciated, the invention is suited to a wide range of applications, such as for furniture, cabinetry, any other use where it may find utility in joining structural members. A first structural member 10 is shown, which in this instance is a vertical post of a headboard, having a first mating surface 11. At least one keyed slot 20 is defined in the first mating surface 11 of the first structural member 10. A second structural member 30, which in this instance is a horizontal portion of a headboard, has a second mating surface 31 which will abut and be joined to the first mating surface 11. A joining wedge 40 is attached to the second mating surface 31, for cooperative engagement with keyed slot 20, as herein described.

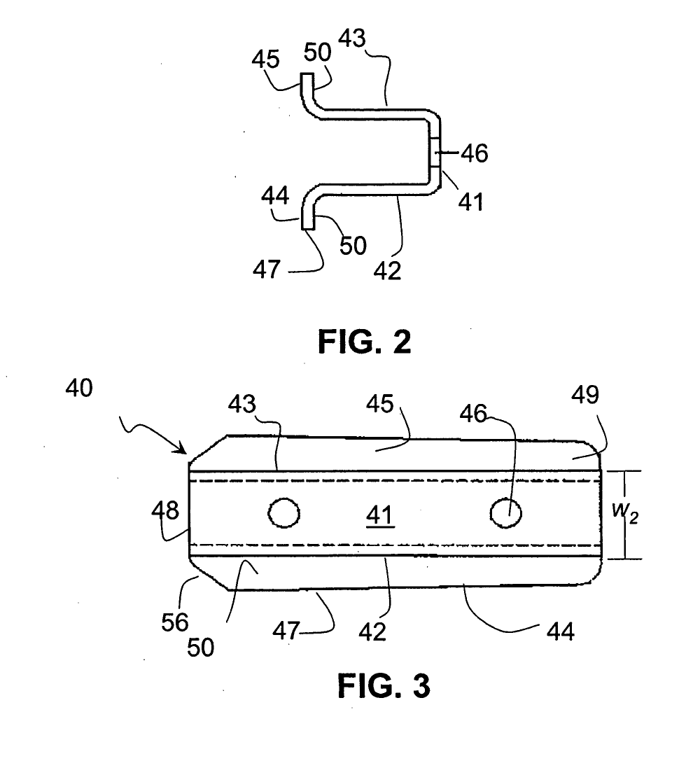

In reference to FIGS. 2-5, joining wedge 40 is a substantially U-shaped or box shaped channel when viewed from its ends. Wedge 40 has a top surface 41 interconnecting a first side surface 42 and a second side surface 43, which side surfaces or legs extend downwardly from top surface 41. A first flange 44 and a second flange 45 extend outwardly and substantially perpendicular to their respective side surfaces 42 and 43.

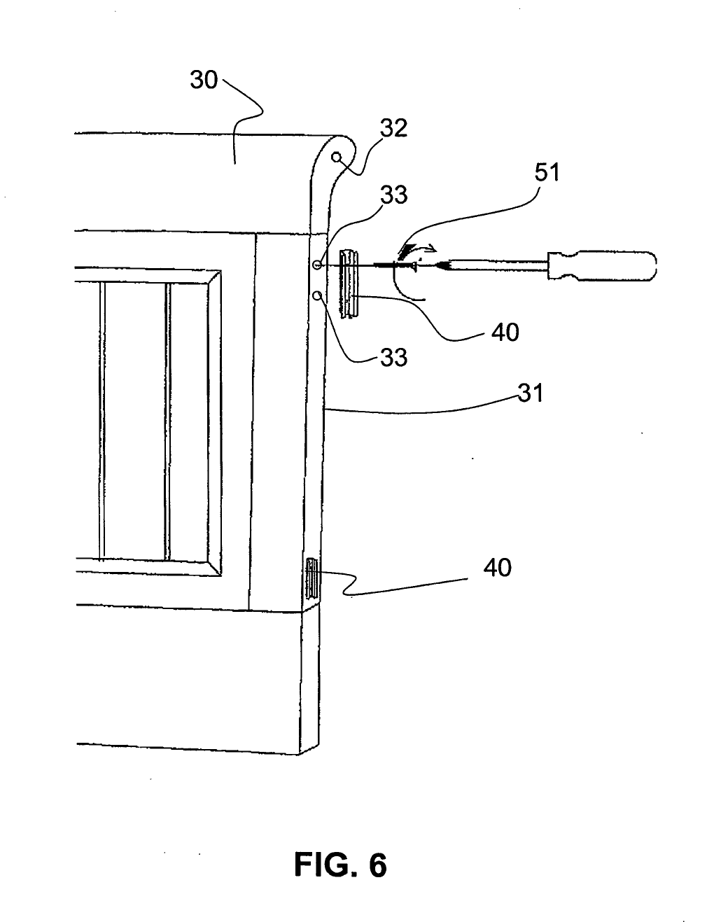

As may be seen in reference to FIG. 3, joining wedge 40 has one or more apertures 46 for receiving a fastener 51, such as a pin, bolt or screw, and the like, to attach joining wedge 40 to the second structural member 30, via one or more receiving holes 33 such as shown in FIGS. 1 and 6, so that the top surface 41 is adjacent to the second mating surface 31. The ends of the flanges 44, 45 are preferably tapered or rounded, beginning at the junction of the flanges 44, 45 with their respective side surfaces 42, 43 and extending to the lateral edges 47 of the flanges 44, 45.

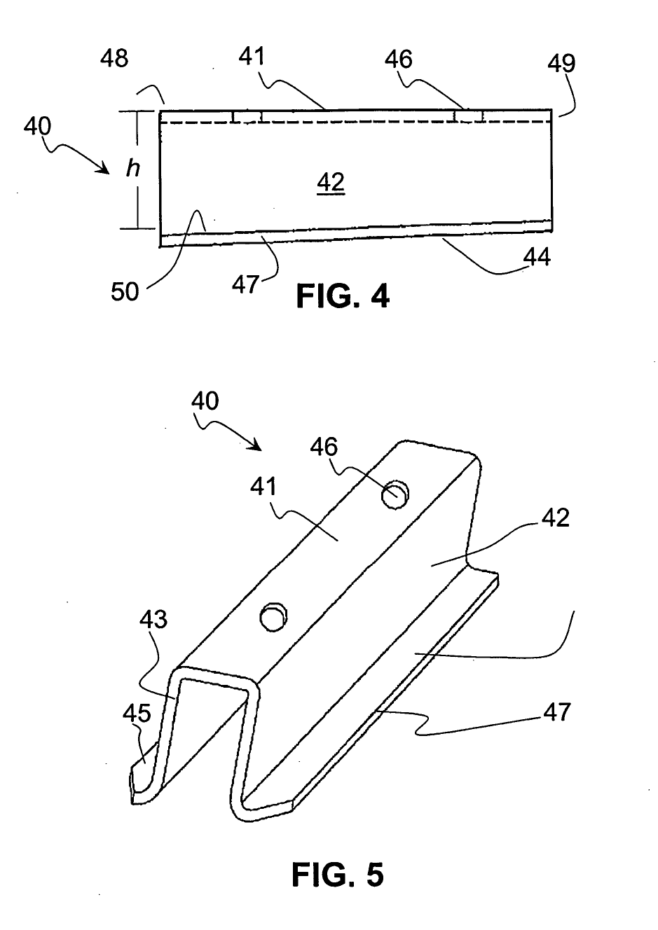

Referring to FIG. 4, close inspection of the drawing will show a preferred embodiment in which the height h of the side surfaces (42 in this view) is gradually reduced between a first end 48 of the joining wedge 40 and a second end 49 of the joining wedge 40, such that the distance between the top surface 41 and an upper surface 50 of the flanges 44, 45 is reduced between the first end 48 of the joining wedge 40 and the second end 49 of the joining wedge 40. More preferably, the height h of the side surfaces will be continuously reduced from the first end 48 of the joining wedge 40 to the second end 49 of the joining wedge 40, where the effective height h of the joining wedge 40 is defined by the distance between the top surface 41 and an upper surface 50 of the flanges 44, 45.

Other preferred embodiments of the joining wedge 40 may include varying the lateral spacing between the lateral edges 47 of the flanges 44, 45 so that the joining wedge 40 will have a slight taper between the first end 48 and the second end 49 of the joining wedge 40, such that the second end 49 is narrower than the first end 48.

In the preferred embodiment depicted, joining wedge 40 may be readily formed from a stamped or formed piece of material, such as sheet metal or other suitable material, according to methods well known in the art. Alternatively, joining wedge 40 may be formed as a solid member from any suitable material providing the requisite structural loading capacity.

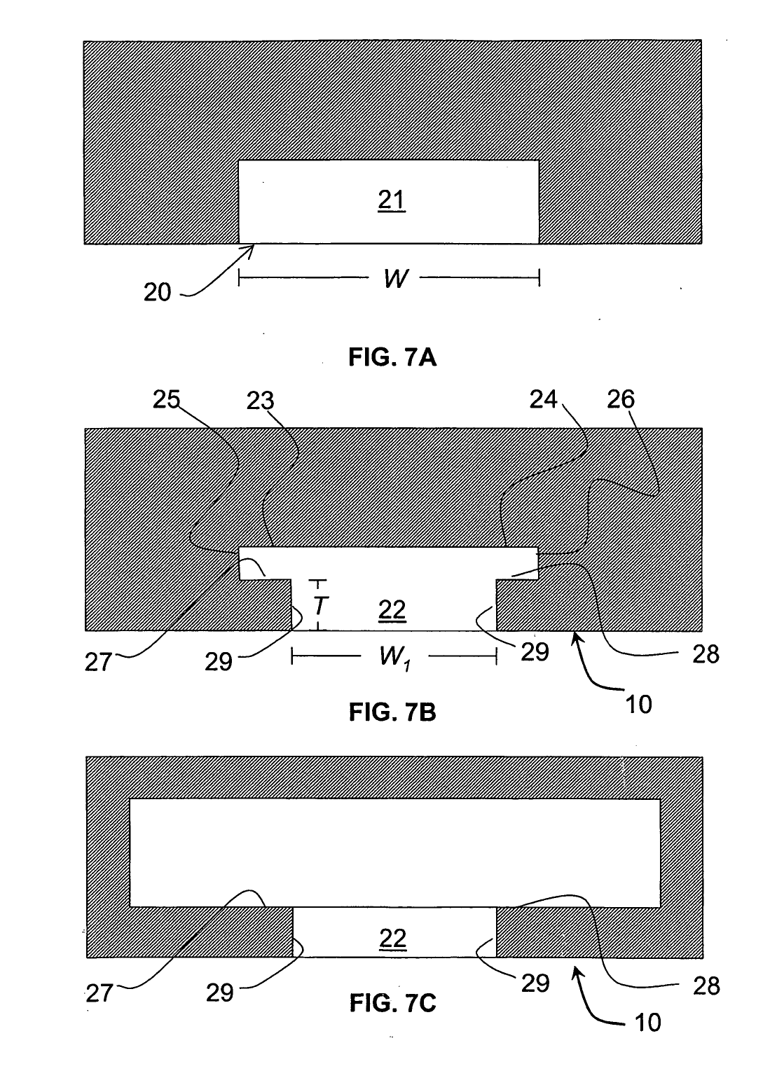

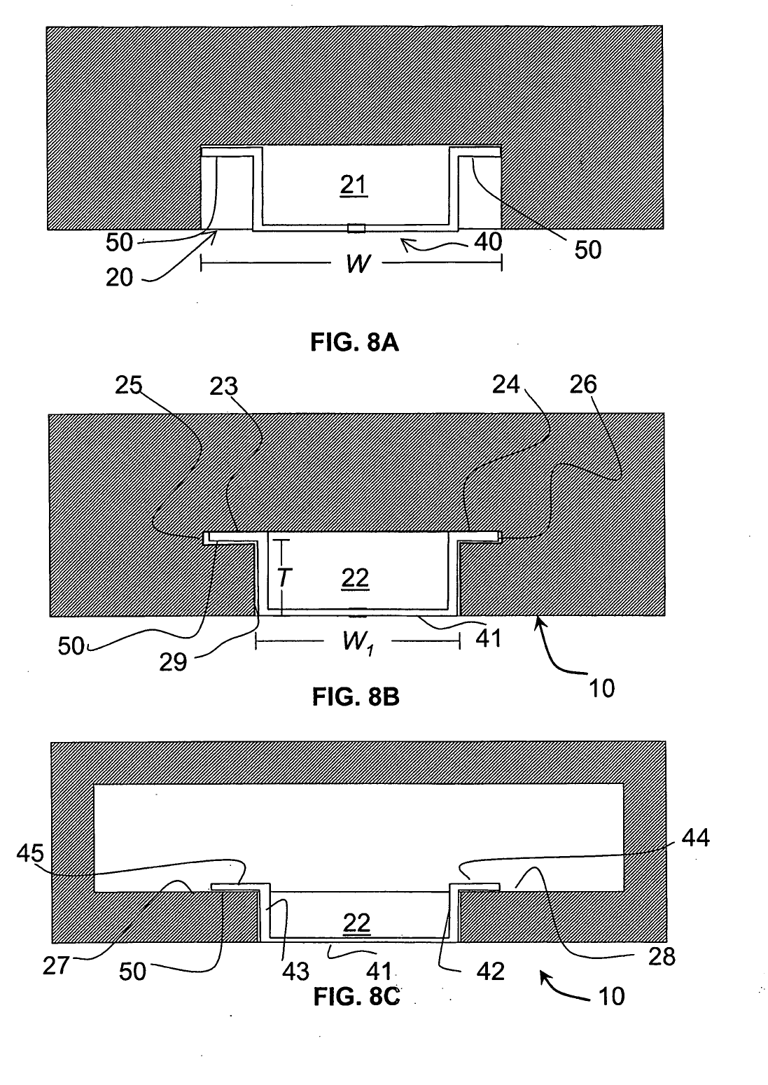

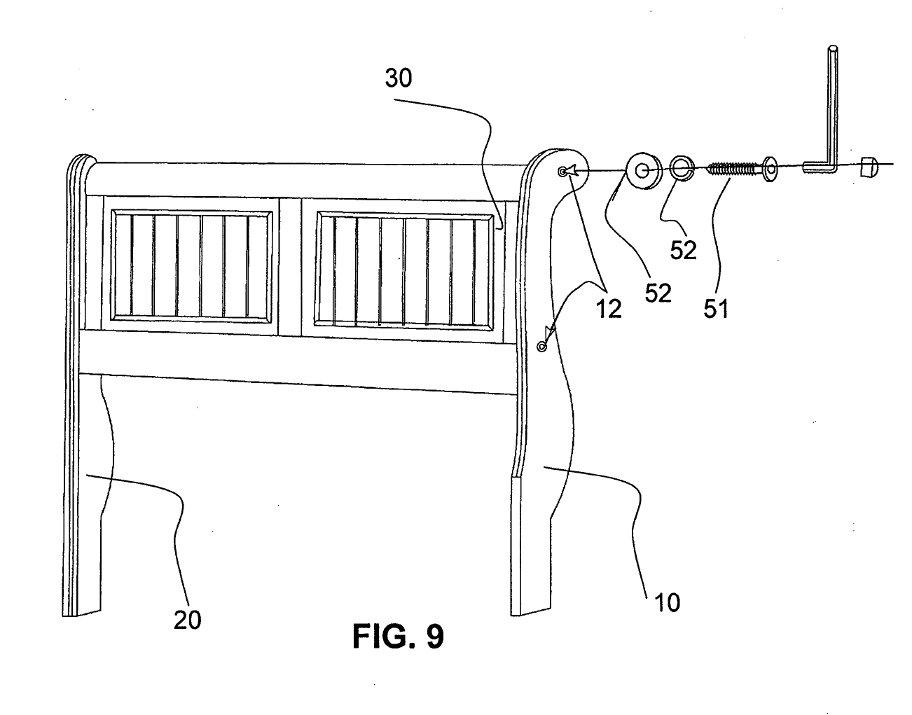

A preferred embodiment of a keyed slot 20 is depicted in detail in FIGS. 7A-8C, in which FIGS. 7A and 8A depict sectional views of the first opening 21 along a line A-A of FIG. 1. Likewise, FIGS. 7B and 8B depict sectional views of a second opening 22, drawn along line B-B of FIG. 1, in which the first opening 21 is substantially wider than the second opening 22. First opening 21 has a width W corresponding to the width of the joining wedge 40 between the edges 47 of flanges 44, 45, and a length corresponding to the longitudinal length of joining wedge 40. If formed in a solid material, first opening 21 should have a depth such that joining wedge 40 may be completely received therein, such that the respective first 11 and second 31 mating surfaces will be in abutment when the structural members are joined.

The second opening 22 should have a width W₁ corresponding to the width of the joining wedge 40, such that it should be at least equal to or greater than the width between the first side surface 42 and the second side surface 43, and substantially less than the width between the edges 47 of flanges 44, 45. In embodiments where the spacing between the lateral edges 47 is reduced along the longitudinal length of the wedge 40, the width W₁ of the second opening 22 is preferably wider than that of the narrower second end 49 and substantially equal or slightly wider than the width of the wedge near the wider first end 48. With tapered end 56, this arrangement permits easier initial engagement and positive centering of the wedge 40 into the second opening 22as the wedge 40 is moved further into second opening 22, as described below.

If a solid material is selected for first member 10, the second opening 22, should also include a first channel 23 and a second channels 24 defined beneath the first mating surface 11 along the length of second opening 22 such that the width between the respective ends 25, 26 of slots 23, 24 is sufficient to receive the flanges 44, 45 of joining wedge 40 therein. As with, first opening 21, second opening 22 should have a depth sufficient to receive the joining wedge 40.

The thickness T of second opening 22, defined by the distance between the first mating surface 11 and a subjacent walls 27, 28 of channels 23, 24, will vary depending on the strength of the material selected for constructing first structural member 10. If a hollow material is selected for first member 10, as depicted in FIGS. 7C and 8C, the subjacent walls 27, 28 may simply be the interior walls of the member, or may alternatively be defined into the surface of the interior walls of the member 10. Consequently, the effective height of joining wedge 40 will also vary according to the materials selected for constructing first structural member 10. By way of example, a first structural member constructed of wood or medium density fiberboard (MDF), an effective height of roughly between about ½ to ¾ inches would be suitable for most applications.

Having described key components of the invention, the method of assembling structural members according to the present invention will now be described. As seen again in reference to FIG. 1, one or more keyed slots 20 as previously described, are formed in the first mating surface 11 of the first structural member 10.

As may be seen in reference to FIG. 6, one or more joining wedges 40 are attached to the second mating surface 31 of the second structural member 30. Joining members should be attached at positions corresponding to the joining wedge 40 position when seated within the second opening 22 in its assembled state, such as shown in FIGS. 1 and 9. When more than one joining wedge 40 is used they should preferably be attached to the second structural member 30 with the same lengthwise orientation, that is, so that their taller first ends 38 are disposed so as to be oriented proximal to the second opening 22 and their shorter second ends 38 are distal to the second opening 22 when they are received in the first openings 21. A plurality of joining wedges 40, as with their associated keyed slots 20, should also be disposed so that their longitudinal axes are aligned in parallel, and more preferably in the same plane. The structural members 20, 30 are then generally aligned in their respective spatial relationships so that joining wedge 40 may be inserted into the first opening 21 of its corresponding keyed slot 20, as depicted by the directional arrows 1, in FIG. 1.

When all joining wedges 40 are received in their respective first openings, the first 10 and second 30 structural members are moved relative one another, as depicted by the directional arrow 2 shown in FIG. 1, in order to seat the wedges 40 within keyed slot 20. The tapered ends of flanges 44, 45, particularly on the first end 38 of the joining wedge will facilitate engagement of the flanges 44, 45 within the respective channels 23, 24 of the second opening 22. As the joining wedges 40 are moved within their respective keyed slots 20, the preferred variable effective height h, will cause upper surfaces 50 of flanges 44, 45 to impinge subjacent walls 27, 28 to draw the structural members 10, 30 in tight abutment with one another. In embodiments with variable widths between the lateral edges 47 of the flanges 44, 45, the wider first end 38, will facilitate centering of the wedge 40 within the channels 23, 24, while reducing the surface contact within channels 23, 24 as more of the wedge 40 is received in the second opening 22.

While gravity will generally act upon structural members 10, 30 to maintain their abutment with one another, particularly where the wedge 40 is a double tapered embodiment, that is the height h decreases and the width w₂ decreases from the first end 48 to the second end 49. Should the user find it necessary to reposition a piece of furniture constructed according to the method and apparatus of the invention, it is preferable that structural members 10, 30 be retained in their respective joined positions so as to avoid separation of the pieces during such repositioning. As may be seen in reference to FIG. 9, preferably one or more bores 12 are defined through first structural member 10 and a corresponding bore 32 is defined in the second mating surface 31 such that bores 12, 32 receive a fastener 51 so as to retain joining wedge 40 within keyed slot 20. With a threaded fastener 51, flat 52 and lock 53 washers are preferably utilized to retain fastener 51 in place. Where bores 12 are countersunk, plugs 54 may also be utilized to mask the presence of the fasteners 51.

The method of joining structural members utilizing the disclosed joining wedge 40 and keyed slot 20 is well suited to the manufacture and delivery of furniture units in an unassembled condition. Keyed slots 20, and the respective bores 12, 32 and holes 33 may be preformed in structural members 10 and 30 at a factory. The respective wedges 40, fasteners 51, and related hardware may be included in a kit for final assembly by the consumer, or at a retail outlet selling such furniture in an assembled condition.

Those of skill in the art will recognize the many alterations, additions or changes to the embodiments may be made without departing from the scope of the appended claims.

I claim:

1. A wedge for joining structural members comprising: a first side surface and a second side surface substantially parallel the first side surface interconnected by a top surface along the upper ends of the first and second side surfaces, and a first flange and a second flange that extend outwardly from and substantially perpendicular to the respective first and second side surface members.

2. The wedge of claim 1 wherein the distance between the top surface and an upper surface of the first and second flanges varies from a first end of the wedge to a second end of the wedge.

3. The wedge of claim 1 wherein the distance between the top surface and an upper surface of the first and second flanges decrease between a first end of the wedge and a second end of the wedge.

4. The wedge of claim 2 wherein the distance between the top surface and the upper surfaces varies continuously from a first end of the wedge to a second end of the wedge.

5. The wedge of claim 1 further comprising one or more apertures defined through the top surface of the wedge.

6. The wedge of claim 1, wherein the wedge is substantially U-shaped and is formed from stamped sheet metal.

7. The wedge of claim 1, wherein the width between first and second side surfaces decreases between a first end of the wedge and a second end of the wedge.

8. The wedge of claim 1, wherein the wedge is a solid body.

9. A method of joining structural members comprising:
a. providing a first structural member having a first mating surface;
b. defining a keyed slot having a first opening coterminous with a second opening in said first mating surface;
c. providing a second structural member having a second mating surface;
d. attaching a joining wedge to the second mating surface;
e. positioning the first structural member relative to the second structural member such that the joining wedge is received in the first opening of the keyed slot;
f. moving the first structural member relative the second structural member such that the joining wedge is received in the second opening in the keyed slot and the first structural member and the second structural member are urged into abutment with one another.

10. The method of claim 9 wherein the joining wedge comprises: a first side surface member and a second side surface member interconnected by a top surface member along the upper ends of the first and second side surface members, a first flange and a second flange extend outwardly from the respective first and second side surface members, and the joining wedge is attached to the second structural member with the top surface adjacent to the second mating surface.

11. The method of claim 10 wherein the distance between the top surface of the joining wedge and an upper surface of the first and second flanges decreases between a first end of the joining wedge and a second end of the joining wedge.

12. The method of claim 10, wherein the second opening further comprises: a first channel and a second channel defined subjacent to the first mating surface, and the first flange and the second flange are received in the respective first and second channels during the step of moving the first structural member relative the second structural member.

13. The method of claim 11, wherein the second opening further comprises: a first channel and a second channel defining a wall subjacent to the first mating surface, and the first flange and the second flange are received in the respective first and second channels during the step of moving the first structural member relative the second structural member, wherein the upper surfaces of the flanges impinge the wall during relative movement of the.

14. The method of claim 9, further comprising the step of restricting movement of the first structural member relative the second structural member after the joining wedge is received in the second opening.

15. A structural joint for furniture components comprising: a keyed slot having a first opening and a second opening coterminous with the first opening and defined in a first mating surface of a first structural member, the second opening defining a pair of channels having a wall subjacent to the first mating surface; a wedge comprising a top member attached to a second mating surface on second structural member, the top member interconnecting a pair of substantially parallel legs that extend along a length of the top member away from the second structural member, a flange that extends outwardly from and substantially perpendicular to each of the legs; the wedge having an effective height defined between the top member and a surface of the flanges proximal the top member; wherein the wedge is received through the first opening and the wedge flanges are slidingly received into the channels.

16. The structural joint of claim 15, wherein the effective height of the wedge decreases between a first end of the wedge and a second end of the wedge and wedge flanges are urged in abutment with the subjacent wall.

17. The structural joint of claim 16, wherein the flange is received in the second opening and the flange surface proximal the top member impinges the channel wall subjacent the first mating surface.

18. The structural joint of claim 15 or 16, wherein the width between the legs decreases between a first end of the wedge and a second end of the wedge.
